(19) United States
(12) Patent Application Publication
(10) Pub. No.: US 2021/0102918 A1
(43) Pub. Date: Apr. 8, 2021

(54) PULSED FIELD MAGNETOMETRY METHOD AND APPARATUS TO COMPENSATE FOR ZERO SIGNAL ERRORS IN A MATERIAL CHARACTERISATION PROCESS

(71) Applicants: James CLEWETT, Falmouth Cornwall (GB); John DUDDING, Falmouth Cornwall (GB); Robin Nathan CORNELIUS, Falmouth Cornwall (GB)

(72) Inventors: James CLEWETT, Falmouth Cornwall (GB); John DUDDING, Falmouth Cornwall (GB); Robin Nathan CORNELIUS, Falmouth Cornwall (GB)

(21) Appl. No.: 17/044,873

(22) PCT Filed: Apr. 1, 2019
(86) PCT No.: PCT/GB2019/050942

§ 371 Date: Oct. 2, 2020

(30) Foreign Application Priority Data
Apr. 2, 2018 (GB) 1805405.6

(51) Int. Cl. G01N 27/72

(52) U.S. Cl. CPC G01N 27/72

(57) ABSTRACT

Pulsed Field Magnetometry (PFM) method and apparatus to compensate for zero signal errors in a material characterisation process involving first constructing a synthesised zero signal expressed with a range of variable parameters. A measurement cycle is performed on a sample of material to be characterised the waveform data obtained in said measurement cycle is stored. The synthesised zero signal is then applied to the stored data while adjusting the values of the variable parameters, and the values are selected which best fit the synthesised zero signal to the stored data. The synthesised zero signal with the selected values is then removed from the stored data to obtain compensated material characterisation data.

### TECHNICAL FIELD OF THE INVENTION

This invention relates to a method and apparatus to compensate for zero signal errors in a material characterisation process.

### BACKGROUND

In many forms of instrumentation associated with the characterisation of materials, there can be a signal “signature” that underlies the characteristics that are measured. This signature can be specific to a particular characterisation technique, or indeed a specific instrument. The signature is referred to as a zero signal because when the instrument is used in a normal characterisation process, without a sample of material, a signature is still obtained.

It is common practice to mathematically subtract this zero signal from the characterisation measurement cycle data to obtain a resulting characteristic that has greater integrity. Sometimes the zero signal can be small with respect to the sampled signal, but in the case of, say, small samples, or weak measurement data, the zero signal can be quite significant due to the limitations of the sample size/volume, or instrumentation. The zero signal can also change with temperature or other physical effects.

One such characterisation technique is pulsed field magnetometry or PFM, which is typically used to magnetically characterise permanent magnet materials. Due to the fundamental physics of the characterisation technique, when a measurement is made without a measurement sample there is a zero signal. In the case of PFM, the zero signal is dependent upon the electrical characteristics of the immediate magnetic environment, temperature and mechanical factors. The normal process during a material characterisation measurement is to take two measurements cycles, one with the material sample (measurement) and one without (zero signal). The measurement data is, in reality, a combination of the material characteristic and the unknown, zero signal. It is then assumed that the zero signal cycle measurement (without the sample) is identical to what it was during the measurement cycle, but this is not always the case. The temperature of the components of the magnetic environment may not be the same in the two measurement cycles. Mechanical movement may also occur between the measurement cycles. These and other factors can all produce significant changes in the zero signal, causing significant inaccuracies in the corrected data.

In practical applications of PFM, the mechanical arrangements are normally designed for good short term stability, and the zero signal measurement it attempted when the magnetic environment is at the same temperature as it was during the measurement cycle. Nevertheless, unknown errors can still exist which affect the accuracy of the corrected measurement.

In general, disadvantages of the existing approach can be summarised as follows:—
1) The measurement of the zero signal will never be perfect, as there will always be a degree of systematic noise contaminating the zero signal.
2) The temperature of the magnetic environment between the two characterisation cycles will never be perfectly the same.
3) The overall characterisation process will take twice as long for each characterisation when measuring a zero signal.

The length of the characterisation process can be reduced by saving a zero signal that is applied to all measurement cycles. Inevitably the longer term mechanical arrangements will “creep.” The effect of which is to change the true, underlying zero signal, reducing overall accuracy.

### SUMMARY OF THE INVENTION

The method of performing a material characterisation process which is described herein uses a technique where a zero signal is not measured as part of the measurement cycle, and is not a saved zero signal, but is instead deduced from the data present in a characterisation measurement, and is mathematically removed without the need for a separate zero signal cycle.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a graphical representation of an unknown zero signal which may be present in a material characterisation process;

FIG. 2 is a graphical representation of the wanted material characterisation data; and

FIG. 3 is a graphical representation of the measured material characterisation data, which includes the unwanted zero signal.

### DETAILED DESCRIPTION OF THE DRAWINGS

The following method is suitable to be performed by material characterisation apparatus such as PFM apparatus. The subject method involves first constructing a synthesised zero signal which is expressed with a range of appropriate variable parameters. The synthesised zero signal is not one particular signature, but is expressed with a range of variables which can be independently adjusted to tune the synthesised signal through a wide spectrum of possible signatures.

The well-documented physics of PFM determines how the variables may impact on the zero signal through
a) temperature changes
b) mechanical movement/magnetic coupling changes
c) material electrical resistivity changes.

The synthesised zero signal function can be determined through theoretical physics considerations, or built empirically using large amounts of data for known zero signals while changing the variables.

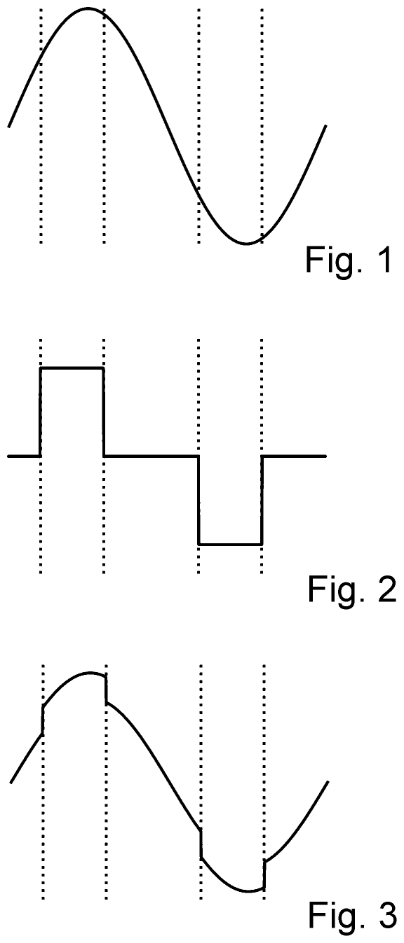

When a measurement cycle is performed on a sample of material to be characterised the resulting stored data will contain an unknown zero signal. By way of illustrative example, FIG. 1 shows a zero signal waveform which may be present in addition to the wanted characterisation measurements, which are shown by way of example in FIG. 2. The resulting measurement data, shown in FIG. 3, will therefore contain both the unknown zero signal as well as the wanted data.

The underlying signature of the synthesised zero signal will have a relationship to the unknown zero signal, but the values of the variables which describe the precise relationship are unknown. In order to ascertain the values of the variables the synthesised zero signal is mathematically superimposed on the stored measurement data and the variables are adjusted until a best fit is determined. By way of illustration, a superimposed signal which is related to the unwanted signal shown in FIG. 1 may have its frequency, phase and amplitude adjusted when applied to the signal of FIG. 3. With some values the synthesised waveform will interfere with the unwanted signal and produce increased disturbance to the waveform, but when the values approach those of the unknown signal the amount of interference becomes significantly smaller, indicating a best fit condition. In the above example these adjustments can take account of the unknown variables (a) to (c) above without directly determining them. The variable parameters of the resultant synthesised zero signal can now be fixed at the best fit values, and the synthesised zero signal with the fixed parameter values subtracted from the stored measurement data using conventional methods.

In the case of the PFM, the initial zero signal transient, overall magnitude and phase are modeled, adjusted, and compared to the measurement cycle data. An optimum synthesised zero signal is determined and then mathematically subtracted from the measurement cycle data.

The advantages of the method are:—
i) Characterisation measurements can be made without the need for an associated zero signal measurement cycle.
ii) The synthesised zero can be free of systematic noise, either through theoretical modeling or projections of empirical data.
iii) Variations in the zero signal due to temperature changes, Mechanical movement/magnetic coupling changes and material electrical resistivity changes can all be accommodated without the need for a measurement of a new Zero signal cycle.

The effect of this is to enable characterisation of materials at a higher rate than the conventional technique, with better accuracy in conditions that may be variable. (Temperature, mechanical etc.)

Whilst the above description places emphasis on the areas which are believed to be new and addresses specific problems which have been identified, it is intended that the features disclosed herein may be used in any combination which is capable of providing a new and useful advance in the art.

1. A method of performing a material characterisation process compensating for zero signal errors:
constructing a synthesised zero signal expressed with a range of variable parameters;
performing a measurement cycle on a sample of material to be characterised and storing the data obtained in said measurement cycle;
applying the synthesised zero signal to the stored data and adjusting the values of said variable parameters;
selecting the values which best fit the synthesised zero signal to the stored data; and
removing the synthesised zero signal with the selected values from the stored data obtained in the measurement cycle to obtain compensated material characterisation data.

2. A method according to claim 1 wherein the said variable parameters of the synthesised zero signal include one or more of:
frequency
position of the zero signal transient
phase
amplitude

3. A method according to claim 1 wherein the synthesised zero signal is applied to the stored data by superimposing the synthesised zero signal on the waveform obtained during the measurement cycle.

4. A method according to claim 3 wherein the values of said variable parameters are selected which produce the minimum amount of disturbance to the waveform obtained during the measurement cycle.

5. A method according to claim 1 wherein the material characterisation process is performed by pulsed field magnetometry (PFM).

6. Apparatus for performing a material characterisation process compensating for zero signal errors:
means for constructing a synthesised zero signal expressed with a range of variable parameters;
means performing a measurement cycle on a sample of material to be characterised;
means for storing the data obtained in said measurement cycle;
means for applying the synthesised zero signal to the stored data and adjusting the values of said variable parameters;
means for selecting the values which best fit the synthesised zero signal to the stored data; and
means for removing the synthesised zero signal with the selected values from the stored data obtained in the measurement cycle to obtain compensated material characterisation data.

7. Apparatus according to claim 6 wherein the said variable parameters of the synthesised zero signal include one or more of:
frequency
position of the zero signal transient
phase
amplitude

8. Apparatus according to claim 6 wherein the means for applying the synthesised zero signal to the stored data is arranged to superimpose the synthesised zero signal on the waveform obtained during the measurement cycle.

9. Apparatus according to claim 8 wherein the means for selecting the values of said variable parameters is arranged to select values which produce the minimum amount of disturbance to the waveform obtained during the measurement cycle.

10. Pulsed field magnetometry (PFM) apparatus for performing a material characterisation process compensating for zero signal errors:
means for constructing a synthesised zero signal expressed with a range of variable parameters;
means performing a measurement cycle on a sample of material to be characterised;
means for storing the data obtained in said measurement cycle;
means for applying the synthesised zero signal to the stored data and adjusting the values of said variable parameters;
means for selecting the values which best fit the synthesised zero signal to the stored data; and
means for removing the synthesised zero signal with the selected values from the stored data obtained in the measurement cycle to obtain compensated material characterisation data.

11. Pulsed field magnetometry (PFM) apparatus according to claim 10 wherein the said variable parameters of the synthesised zero signal include one or more of:
frequency
position of the zero signal transient
phase
amplitude

12. Pulsed field magnetometry (PFM) apparatus according to claim 10 wherein the means for applying the synthesised zero signal to the stored data is arranged to superimpose the synthesised zero signal on the waveform obtained during the measurement cycle.

13. Pulsed field magnetometry (PFM) apparatus according to claim 12 wherein the means for selecting the values of said variable parameters is arranged to select values which produce the minimum amount of disturbance to the waveform obtained during the measurement cycle.
